(19) United States
(12) Patent Application Publication
(10) Pub. No.: US 2014/0378368 A1
(43) Pub. Date: Dec. 25, 2014

(54) DUSTED, WATER-SOLUBLE PACKAGING

(71) Applicant: Henkel AG & Co. KGaA, Duesseldorf (DE)

(72) Inventors: Matthias Sunder, Duesseldorf (DE); Friedhelm Siepmann, Essen (DE); Mario Sturm, Leverkusen (DE); Frank Meier, Duesseldorf (DE)

(21) Appl. No.: 14/484,228

(22) Filed: Sep. 11, 2014

Related U.S. Application Data
(63) Continuation of application No. PCT/EP2013/054257, filed on Mar. 4, 2013.

(30) Foreign Application Priority Data
Mar. 14, 2012 (DE) 10 2012 204 014.5

(51) Int. Cl. C11D 17/04; B05D 1/12

(52) U.S. Cl. CPC C11D 17/043; C11D 17/042; B05D 1/12
USPC 510/406; 510/439; 427/180

(57) ABSTRACT

The application describes a water-soluble package which comprises an agent and a water-soluble covering, wherein at least part of an exposed surface of the water-soluble package is dusted with a saccharide-containing powder. Saccharide-dusted water-soluble packages exhibit advantages in terms of their transport properties during the production and packaging process and during storage in a secondary package.

### FIELD OF THE INVENTION

The present invention generally relates to a dusted, water-soluble package which contains an agent and a water-soluble covering. The invention also relates to a method for producing a dusted, water-soluble package.

### BACKGROUND OF THE INVENTION

Today, detergents or cleaning agents are offered for sale to consumers in many and varied presentations. In addition to powders and granules, these also include for example liquids, gels or portion packages (tablets or filled pouches).

Portion packages, e.g. water-soluble packages containing liquid washing or cleaning agents, are in becoming increasingly popular. These portion packages are popular with consumers because they fulfill the consumer's desire for simplified dispensing and the preference for liquid washing or cleaning agents. The water-soluble packages used in these portion packages may be produced by vertical form fill sealing (VFFS) methods or thermoforming methods.

Thermoforming generally includes forming a first layer of a water-soluble film material to produce indentations for receiving a composition, introducing the composition into the indentations, covering the indentations filled with the composition with a second layer of a water-soluble film material and sealing the first and second layers together at least around the indentations. In a subsequent packaging step, a plurality of water-soluble packages are packed in a secondary package, for example a plastic box or a plastic bag. To this end, the water-soluble packages are transported to a packaging unit by means of suitable conveying installations.

Water-soluble packages have the tendency to stick together, if a plurality thereof are stored close together for a period or transported in the course of the manufacturing and packaging process. Immediately after production, the water-soluble packages often exhibit surface tackiness which may have a disadvantageous effect on their processability in the packaging process to the effect that the water-soluble packages have poorer surface slip properties or, if they are conveyed close together, stick to one another and therefore cannot be counted correctly prior to packing in a secondary package.

To avoid these problems, water-soluble packages are known from EP 1498473 Al and EP 1326929 A1 in which at least part of an exposed surface of the package is dusted with a powder. The powders used comprise starch, zinc stearate, calcium stearate and in particular talcum.

There is nevertheless still a need to improve further the processability and storage life of water-soluble packages.

### BRIEF SUMMARY OF THE INVENTION

A water-soluble package which comprises an agent and a water-soluble covering, wherein at least part of an exposed surface of the water-soluble package is dusted with powder, said powder comprising a saccharide with at most 10 monosaccharide units.

A method for producing a water-soluble package which comprises an agent and a water-soluble covering is also provided. The method comprises a step of coating the water-soluble package with a powder which comprises a saccharide with at most 10 monosaccharide units.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides a water-soluble package comprising an agent and a water-soluble covering, which during storage, transportation during the production, and the packaging process does not exhibit any or only a slight tendency to stick to other water-soluble packages and which exhibits improved processability. This is achieved, at least in part, by a water-soluble package that comprises an agent and a water-soluble covering, wherein at least part of an exposed surface of the water-soluble package is dusted with powder which comprises a saccharide with at most 10 monosaccharide units.

Furthermore, other desirable features and characteristics of the present invention will become apparent from the subsequent detailed description of the invention and the appended claims, taken in conjunction with the accompanying drawings and this

### BACKGROUND OF THE INVENTION

It has surprisingly been found that the use of saccharide-containing powders as dusting agents significantly improves the processability of the dusted, water-soluble packages.

In a preferred embodiment of the invention, the saccharide with at most 10 monosaccharide units is selected from the group consisting of monosaccharides, disaccharides, oligosaccharides of 3 to 10 monosaccharide units and mixtures thereof. The saccharide is more preferably selected from the group consisting of D-ribose, D-xylose, L-arabinose, D-glucose, D-mannose, D-galactose, D-fructose, sorbose, L-fucose, L-rhamnose, sucrose, raffinose, trehalose, xylooligosaccharides, galactooligosaccharides, lactose, maltose, cellobiose and mixtures thereof. These saccharides with at most 10 monosaccharide units dissolve very readily in water and do not leave any residues behind on the washed textiles after washing. Moreover, these saccharides are odor-neutral.

The saccharide with at most 10 monosaccharide units is more preferably lactose. It has been found that water-soluble packages dusted with lactose have improved transport properties in the production and packaging process.

It is preferred for the saccharide with at most 10 monosaccharide units to have a particle size D(v, 50) of 1 to 100 μm and more preferably a particle size D(v, 50) of 5 to 30 μm. The use of small particle sizes has the advantage that dusting of the water-soluble package is barely or not at all visible to a consumer.

It is moreover preferable for the powder to be present on the exposed surface of the water-soluble package in a quantity of 0.75 to 8 mg/1000 mm² It has been found that even small quantities of saccharide are sufficient to improve the processability and storage life of water-soluble packages.

It is preferred for the water-soluble covering to comprise polyvinyl alcohol or a polyvinyl alcohol copolymer. Water-soluble coverings which comprise polyvinyl alcohol or a polyvinyl alcohol copolymer have good stability combined with a sufficiently high water solubility, in particular cold water solubility.

The agent is more preferably a liquid washing or cleaning agent. Water-soluble packages containing a liquid washing or cleaning agent not only fulfill the consumer's desire for simplified dispensing but are also easier to handle than non-portioned liquid washing and cleaning agents, since for example no drops remain on the rim of the bottle which lead on subsequent storage of the bottle to rings on the surface underneath or to unattractive deposits in the closure region. Furthermore, no residues remain in the dispensing compartment.

The present invention also provides a method for producing a water-soluble package comprising an agent and a water-soluble covering. The method comprises a step of coating the water-soluble package with a powder which comprises a saccharide with at most 10 monosaccharide units.

The invention will be explained in greater detail below, inter alia with reference to examples.

The present invention provides a water-soluble package which comprises an agent and a water-soluble covering and which is dusted with a saccharide with at most 10 monosaccharide units.

A water-soluble package comprises a water-soluble covering. The water-soluble covering is preferably formed by a water-soluble film material.

The water-soluble covering is preferably made of a water-soluble film material selected from the group consisting of polymers or polymer blends. The covering may be formed of one or of two or more layers of the water-soluble film material. The water-soluble film material of the first layer and further layers, if present, may be identical or different.

It is preferred for the water-soluble covering to contain polyvinyl alcohol or a polyvinyl alcohol copolymer.

Suitable water-soluble films for producing the water-soluble covering are preferably based on a polyvinyl alcohol or a polyvinyl alcohol copolymer, the molecular weight of which is in the range from 10,000 to 1,000,000 gmol⁻¹, preferably from 20,000 to 500,000 gmol⁻¹, more preferably from 30,000 to 100,000 gmol⁻¹ and in particular from 40,000 to 80,000 gmol⁻¹.

Polyvinyl alcohol is conventionally produced by hydrolysis of polyvinyl acetate, since the direct synthetic pathway is not possible. The same is true of polyvinyl alcohol copolymers, which are accordingly produced from polyvinyl acetate copolymers. It is preferred for at least one layer of the water-soluble covering to comprise a polyvinyl alcohol having a degree of hydrolysis of 70 to 100 mol %, preferably of 80 to 90 mol %, more preferably of 81 to 89 mol % and in particular of 82 to 88 mol %.

A polymer selected from the group comprising acrylic acid-containing polymers, polyacrylamides, oxazoline polymers, polystyrenesulfonates, polyurethanes, polyesters, polyethers, polylactic acid or mixtures of the above polymers may additionally be added to a film material suitable for producing the water-soluble covering.

In addition to vinyl alcohol, preferred polyvinyl alcohol copolymers comprise dicarboxylic acids as further monomers. Suitable dicarboxylic acids are itaconic acid, malonic acid, succinic acid and mixtures thereof, wherein itaconic acid is preferred.

In addition to vinyl alcohol, preferred polyvinyl alcohol copolymers likewise comprise an ethylenically unsaturated carboxylic acid, the salt thereof or the esters thereof. In addition to vinyl alcohol, such polyvinyl alcohol copolymers more preferably contain acrylic acid, methacrylic acid, acrylic acid esters, methacrylic acid esters or mixtures thereof.

Suitable water-soluble films for use in the coverings of the water-soluble packages according to the invention are films which are distributed for example by MonoSol LLC for example under the names M8630, C8400 or M8900. Other suitable films comprise films known as Solublon® PT, Solublon® GA, Solublon® KC or Solublon® KL from Aicello Chemical Europe GmbH or VF-HP films from Kuraray.

In addition to the water-soluble covering, the water-soluble package comprises an agent. This agent may for example comprise a powder, a granular product or a liquid. More preferably, the agent is a washing or cleaning agent and still more preferably a liquid washing or cleaning agent.

The agent contains ingredients which do not destroy the structural integrity of the water-soluble covering. If the agent used is a liquid washing or cleaning agent, it may contain one or more substances from the group of surfactants, builders, bleaching agents, enzymes, electrolytes, pH adjusting agents, perfumes, perfume carriers, fluorescent agents, dyes, hydrotropes, foam inhibitors, silicone oils, antiredeposition agents, graying inhibitors, shrinkage prevention agents, anticrease agents, dye transfer inhibitors, antimicrobial active substances, non-aqueous solvents, germicides, fungicides, antioxidants, preservatives, corrosion inhibitors, antistatic agents, bitter agents, ironing aids, waterproofing and impregnation agents, skin-conditioning active ingredients, antiswelling and antislip agents, softening components and UV absorbers.

The washing or cleaning agents are liquid. The washing or cleaning agents may contain water, wherein the water content amounts to less than 10 wt. % and more preferably less than 8 wt. %, in each case relative to the total liquid washing or cleaning agent.

The water-soluble package is dusted with a powder which comprises a saccharide with at most 10 monosaccharide units. In a more preferred embodiment, a water-soluble package is dusted with a powder which consists of one or more saccharide(s) with at most 10 monosaccharide units.

The saccharide with at most 10 monosaccharide units is preferably selected from the group consisting of monosaccharides, disaccharides, oligosaccharides of 3 to 10 monosaccharide units and mixtures thereof. The saccharide with at most 10 monosaccharide units is in particular selected from the group consisting of D-ribose, D-xylose, L-arabinose, D-glucose, D-mannose, D-galactose, D-fructose, sorbose, L-fucose, L-rhamnose, sucrose, raffinose, trehalose, xylooligosaccharides, galactooligosaccharides, lactose, maltose, cellobiose and mixtures thereof. The saccharide with at most 10 monosaccharide units preferably contains a disaccharide.

In one more preferred embodiment, the powder comprises lactose and in a particularly preferred embodiment the powder consists of lactose. The lactose is preferably used in monohydrate form. A commercially available lactose monohydrate suitable for dusting water-soluble packages is for example ESZET 15 from KSL Staubtechnik.

The saccharide with at most 10 monosaccharide units preferably has a particle size D(v, 50) of 1 to 100 μM and more preferably a particle size D(v, 50) of 5 to 30 μm.

The particle size D(v, 50) may be determined for example using “Mastersizer® 2000” particle size analyzer from Malvern Instruments, Malvern, Great Britain, which is based on laser diffraction. This device uses laser diffraction technology to determine the particle sizes and particle size distribution of fine powders. A small powder sample is fluidized with dry compressed air and conveyed through a screen into a measurement cell, in which it is exposed to a laser beam. The pattern of the scattered laser light is characteristic of a specific particle size distribution. The Malvern software analyzes this pattern on the basis of spherical particles and presents the result in the form of a particle diameter histogram.

The determined results may be stated as volumetric diameters (D(v)) or indeed also as numerical diameters (D(n)).

The particle size D(v, 50) indicates the average particle size. This means that 50% of the particles are smaller than the stated value.

In one embodiment, the powder comprises a scent in addition to the saccharide with at most 10 monosaccharide units. One problem associated with water-soluble packages is that with scented agents the scent does not pass through the water-soluble covering, such that the water-soluble package does not have an unmistakable odor or indeed has the odor of the film material of the water-soluble covering, which is frequently unacceptable to consumers. This problem may be solved by using a powder which comprises a saccharide with at most 10 monosaccharide units and a scent.

The powder may be applied in any desired suitable manner to a water-soluble package. One such option is to dissolve or suspend the powder in a non-aqueous solvent, which is then atomized and sprayed onto the water-soluble package. However, in this method a considerable amount of solvent arises, which may be inherently dangerous and must be recovered and condensed.

In an alternative method, the powder can be applied to the water-soluble package using rotating brushes which are in contact with the powder. Another method makes use of gravity to cause the water-soluble packages to slip over a powdered surface. Powder transfer and movement of the water-soluble packages may be improved by vibrating the surface. These methods have the advantage that they are not dependent on solvents.

In another method, the powder can be fluidized in air using a swirl chamber. The fluidized powder is then brought into contact with the water-soluble packages. This may proceed by pneumatic conveying of the fluidized powder, wherein the powder stream is directed onto one or more water-soluble packages.

In a further powder coating method, one or more stationary powder spray guns are used to direct the powder stream onto the water-soluble packages which are conveyed through the coating zone by means of a belt conveyor.

In one embodiment of this method attraction between the powder and the water-soluble package is increased by means of electrostatic forces. A powder may be effectively charged if an electrode is installed in the powder spray gun.

It is preferred for the powder to be present on the exposed surface of a water-soluble package after dusting in a quantity of 0.75 to 8 mg/1000 mm².

The water-soluble package, comprising the agent and the water-soluble covering, may comprise one or more chambers. The water-soluble packages with one chamber may have a substantially dimensionally stable spherical, cushion-like configuration with a circular, elliptical, square or rectangular basic shape. The agent may be contained in one or more chambers, if present, of the water-soluble covering.

In a preferred embodiment, the water-soluble package comprises two chambers. In this embodiment the first chamber contains a liquid agent and the second chamber a solid or a liquid agent. In one particularly preferred embodiment, the first chamber contains a liquid washing or cleaning agent and the second chamber a solid or a liquid washing or cleaning agent.

The agents contained in the different chambers of a water-soluble package with two or more chambers may have the same composition. The agents in a water-soluble package with at least two chambers preferably comprise compositions which differ at least in one ingredient or at least in the content of an ingredient.

Water-soluble packages with at least two chambers have the advantage that incompatible ingredients can be present in separate chambers. A further advantage arises in the case of suspensions containing solid and liquid ingredients, which are often regarded by the user of the water-soluble package as unesthetic and/or defective. In such a case the solid or insoluble ingredients can be contained in a separate chamber of the water-soluble package.

### EXAMPLES

Liquid washing or cleaning agents were produced using conventional, known procedures and methods. Table 1 below shows the compositions of two liquid washing or cleaning agents, Invention 1 and Invention 2.

TABLE 1
Liquid washing or cleaning agents Invention 1 and Invention 2
[all quantities are stated in wt. % of active substance,
relative to the composition]

| Ingredients | Invention 1 | Invention 2 |
|---|---|---|
| C₁₀-C₁₃ alkylbenzenesulfonic acid | 21 | 21 |
| C₁₃-C₁₅ oxo alcohol with 8 EO | 22.5 | — |
| C₁₃-C₁₅ oxo alcohol with 7 EO | — | 22.5 |
| C₁₂₋₁₈ fatty alcohol with 7 EO | — | — |
| C₁₂₋₁₈ fatty alcohol with 3 EO | — | — |
| C₁₂₋₁₈ fatty acid | 17.5 | 17.5 |
| Glycerol | 13 | 13 |
| 1,2-Propanediol | 13.5 | 13.5 |
| Ethanol | 3.26 | 3.26 |
| Phosphonate | 0.3 | 0.3 |
| Monoethanolamine | 6.4 | 6.4 |
| Dyes, enzymes (cellulase, amylase & | 0.8 | 0.8 |
| protease), optical brighteners, perfume | | |
| Water | 1.74 | 1.74 |

To produce water-soluble packages containing the liquid washing or cleaning agents Invention 1 and Invention 2, an M 8630 grade film (e.g. Monosol) with a thickness of 76 μm was drawn by vacuum into a depression to form an indentation. The indentation was then filled with 30 ml of one of the liquid washing or cleaning agents Invention 1 or Invention 2. After covering the indentations filled with the agent with a second layer of an M 8630 grade film, the first and second layers were sealed together. The sealing temperature was 150° C. and the sealing duration was 1.1 seconds. The water-soluble packages were then dusted with lactose monohydrate using a powdering apparatus made by PEKUTECH. The particle size D(v, 50) of the lactose monohydrate was 20 μm. For comparative tests water-soluble packages were also dusted with talcum (108070 PARTECK® LUB from Merck).

To determine transport properties, the rate of travel of the dusted water-soluble packages containing the liquid washing or cleaning agent Invention 1 was determined on a vibration apparatus (KF 12-2, AViTEQ Vibrationstechnik). The time in seconds which the water-soluble packages require to move over a distance of 75 cm was measured as a value for the surface slip of the water-soluble packages. The vibrating surface of special steel (material number 1.4571) was inclined by 7% and was operated at a frequency of 2100 Hz. The mean of 8 measurements was determined in each case.

The rate of travel was determined for freshly dusted water-soluble packages and packages which had been stored for 7 days.

TABLE 2
Rate of travel of water-soluble packages

| | Application rate | Time [s] | Time [s] |
|---|---|---|---|
| Powder | (mg/wV*) | fresh | 7 days |
| None | — | 32.4 | 32.5 |
| Talcum | 11.6 | 30.5 | 50.1 |
| Lactose monohydrate | 10.1 | 26.9 | 31.4 |
| Lactose monohydrate | 15.9 | 24.8 | 28.1 |

*wV = water-soluble package

The results in Table 2 show clearly that water-soluble packages dusted with lactose exhibit better transport properties than water-soluble packages dusted with talcum. It was also found that water-soluble packages dusted with talcum have only slightly better surface slip properties than water-soluble packages which are not dusted at all. It was also particularly striking that the rate of travel of talcum-dusted water-soluble packages was markedly slower after 7 days.

After 4, 8 and 12 weeks' storage of lactose-dusted water-soluble packages including the washing or cleaning agents Invention 1 or Invention 2 under different climatic conditions, no partial or complete dissolution of the water-soluble covering could be observed. In addition, no pores or holes which would likewise result in product escaping or leaking out could be identified.

Lactose-dusted water-soluble packages containing the washing or cleaning agents Invention 1 or Invention 2 dissolved without residue in washing cycles at temperatures in the range from 20 to 95° C. and exhibited very good cleaning performance.

The lactose-dusted water-soluble packages comprising the washing or cleaning agents Invention 1 or Invention 2 showed no tendency to stick together even after 12 weeks' storage in a plastic bag made of a polyethylene terephthalate-polypropylene film composite (16 water-soluble packages per bag). In contrast, the talcum-dusted water-soluble packages had a slight tendency to stick together.

Table 3 below shows the compositions of two further washing or cleaning agents Invention 3 and Invention 4 which are used in water-soluble packages according to the invention.

TABLE 3
Liquid washing or cleaning agents Invention 3 and Invention 4
[all quantities are stated in wt. % of active substance,
relative to the composition]

| Ingredients | Invention 3 | Invention 4 |
|---|---|---|
| Potassium tripolyphosphate | 21 | — |
| Glutaminediacetic acid, sodium salt | — | 21 |
| Sodium citrate | 4 | 4 |
| Hydroxy mixed ethers | 2 | 2 |
| Glycerol | 27 | 27 |
| 1,2-Propanediol | 10 | 10 |
| Sulfopolymer | 9 | 9 |
| Phosphonate | 2.5 | 2.5 |
| Monoethanolamine | 3.5 | 3.5 |
| Dyes, enzymes & perfume | 3 | 3 |
| Water | 18 | 18 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A water-soluble package, comprising:
an agent,
a water-soluble covering, and
a powder including a saccharide with at most 10 monosaccharide units,
wherein the powder is dusted on at least part of an exposed surface of the water-soluble package.

2. The water-soluble package according to claim 1, wherein the saccharide with at most 10 monosaccharide units is selected from the group consisting of monosaccharides, disaccharides, oligosaccharides of 3 to 10 monosaccharide units and mixtures thereof.

3. The water-soluble package according to claim 1, wherein the saccharide with at most 10 monosaccharide units is selected from the group consisting of D-ribose, D-xylose, L-arabinose, D-glucose, D-mannose, D-galactose, D-fructose, sorbose, L-fucose, L-rhamnose, sucrose, raffinose, trehalose, xylooligosaccharides, galactooligosaccharides, lactose, maltose, cellobiose and mixtures thereof.

4. The water-soluble package according to claim 3, characterized in that the saccharide with at most 10 monosaccharide units includes lactose.

5. The water-soluble package according to claim 1, wherein the saccharide has a particle size D(v, 50) of 1 to 100 μm.

6. The water-soluble package according to claim 1, wherein the saccharide has a particle size D(v, 50) of 5 to 30 μm.

7. The water-soluble package according to claim 1, wherein the powder is present on the exposed surface of the water-soluble package in a quantity of 0.75 to 8 mg/1000 mm².

8. The water-soluble package according to claim 1, wherein the water-soluble covering includes polyvinyl alcohol or a polyvinyl alcohol copolymer.

9. The water-soluble package according to claim 1, wherein the agent is a liquid washing or cleaning agent.

10. A method for producing a water-soluble package which contains an agent and a water-soluble covering, wherein the method comprises coating the water-soluble package with a powder which includes a saccharide with at most 10 monosaccharide units.
